(19) United States
(12) Patent Application Publication
(10) Pub. No.: US 2009/0073818 A1
(43) Pub. Date: Mar. 19, 2009

(54) SEEKING CONTROL SYSTEM AND METHOD OF OPTICAL DISC DRIVE

(75) Inventors: Yi-jen Chung, Hsinchu City (TW); Feng-fu Lin, Taipei (TW); Chun-wei Lin, Kao-Hsiung City (TW)

Correspondence Address: AUSTIN RAPP & HARDMAN, 15 WEST SOUTH TEMPLE, SUITE 900, SALT LAKE CITY, UT, 84101, US

(73) Assignee: MEDIATEK Inc., Hsin-Chu City (TW)

(21) Appl. No.: 11/854,701

(22) Filed: Sep. 13, 2007

(51) Int. Cl. G11B 21/08

(52) U.S. Cl. 369/30.1

(57) ABSTRACT

A seeking control system in an optical disc drive is disclosed. The system comprises a servo controller, a velocity control unit, and a switch unit. The servo controller receives a central servo signal to output a first tracking control signal for the tracking coil. The velocity control unit receives a tracking error signal to determine a velocity of the pickup head and compares the velocity of the pickup head with a predetermined velocity profile to generate the second tracking control signal. The switch unit outputs the second tracking control signal instead of the first tracking control signal to the motor driver to control the pickup head moving steadily.

### FIELD OF THE INVENTION

The present invention generally relates to a seeking control system and method of an optical disc drive for stably controlling the seeking operation.

### BACKGROUND OF THE INVENTION

The DVD-RAM type disc employs a wobbled Land/Groove recording method, which is different from the wobbled Groove recording method employed by the other discs, such as CD-RW, DVD-RW or DVD+RW. The data is recorded in both the groove and land of each spiral track on the DVD-RAM disc; therefore a high track density is obtained. However, it results in some difficulties for an optical disc drive to access the DVD-RAM disc.

Please refer to FIG. 1, a functional diagram of an optical disc drive 100. The optical disc drive 100 comprises a pickup head 102, a spindle motor 104, a sled motor 106, a tracking coil 108, an RF amplifier 112, a servo controller 114, and a motor driver 116. An optical disc 120 can be loaded on and rotated by the spindle motor 104. The pickup head (PUH) 102 is located in the tracking coil 108 and the sled motor 106. By controlling the sled motor 106 and the tracking coil 108, the PUH 102 can move in a radial direction of the optical disc 120; and cooperated with the rotation of the optical disc 120, the optical disc drive can access all the optical disc by using the PUH 102.

Generally, an optical disc drive seeks (or called search) the target position first then could follow the track to access the optical disc. This seeking or searching is called a seeking operation. The optical disc drive adopts the reflected signal by the PUH 102 to control the movement of the PUH 102. The reflected signal is converted and amplified into servo signals by the RF Amp 112. The servo signals at least include a TE (Tracking Error) signal and a Tcs (central servo) signal. A servo controller 114 receives these servo signals and generates a TRO (Tracking Output) signal and a FMO signal (a sled motor control signal) to a motor driver 116 to drive the tracking coil 108 and the sled motor 106 so as to move the PUH 102 to the target position. In the seeking operation, the servo controller 114 always tries to keep the tracking coil in the middle of the sled motor, so the TRO signal is generated by compensating the Tcs signal. But as closing to the end of seeking operation, the pickup head 102 would be sometimes controlled to move forward or backward then reduced a “reverse” of the pickup head.

Please refer to FIGS. 2A and 2B, which illustrate two oscillograms of the TE signal when PUH 102 moves through the lands and grooves of an optical disc. FIG. 2A shows that the PUH 5 is driven without reverse, and FIG. 2B shows the PUH 102 is driven with reverse happening. As shown in FIG. 2A, the TE signal will varied from peak to peak when the optical disc move from a land to a groove. In this case, from the peak to bottom of the TE signal means the PUH pass trough a land (shown as “L” in FIG. 2A), and from bottom to peak means the PUH pass through a groove (Shown as “G” in FIG. 2A). As shown in FIG. 2B, there is a “reverse” happened in the point 150, so the meaning of the TE is changed. After the “reverse” occurred, from the peak to bottom of the TE signal means the PUH pass through a groove, and from the bottom to peak means the PUH pass through a land.

As aforementioned, the reverse of the PUH 102 happens sometimes if only Tcs control is employed. If the optical disc is CD-RW, DVD-RW or DVD+RW, which is wobbled Groove recording type, even the reverse does happen, the RFZC and TEZC signal can be a clue to determine the TE polarity, but in DVD-RAM, which is wobbled Land/Groove recording type, when a reverse of the PUH 5 occurs, the polarities of the TE signals corresponding to the Land/Groove of the disc also reverses. As a result, the aforesaid phenomenon makes the seeking control unstable.

### SUMMARY OF THE INVENTION

The present invention provides a seeking control system and method of an optical disc drive for controlling a pickup head stably in a seeking operation. The system comprises a servo controller, a velocity control unit and a switch unit. The servo controller receives a central servo signal (Tcs) to output a first tracking control signal for controlling the tracking coil. The servo controller also provides a sled motor control (FMO) signal for controlling the sled motor. The velocity control unit receives a tracking error (TE) signal to determine the velocity of the pickup head. Then, the velocity control unit compares the velocity of the pickup head with a predetermined velocity profile to generate a second tracking control signal for controlling the tracking coil. The switch unit couples to the servo controller and the velocity control unit. It selects to output one of the first tracking control signal and the second tracking control signal according to the TE signal or the FMO signal.

The switch unit makes a selection between the first and the second tracking control signals by comparing a predetermined frequency with the frequency of the TE signal or by comparing a predetermined number with the number of the pulses of the FMO signal. Alternatively, the switch unit selects to output the second tracking control signal if the seeking operation is in the last portion of the sled motor control signal.

Furthermore, the velocity of the pickup head is obtained from the pulses of the sled motor control signal if a stepping motor is generally used as the sled motor. The pulses supplied to the motor can be employed as a reference for position and velocity of the controlled motor. The switch unit switches from first tracking control signal to the second tracking control signal as the TRO signal to the motor driver to control the pickup head steadily moving without reverse occurring when approaching the ending of the seeking operation.

Accordingly, the seeking control system and the method thereof according to the present invention provides a velocity estimation capable of controlling the pickup head moving steadily without reverse occurring in the seeking operation, especially for the wobbled Land/Groove recording type optical disc. Furthermore, the present invention efficiently prevents the runout event happening while the eccentric optical disc is accessed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 simply and roughly shows an optical recording/reproducing equipment with a basic optical disc drive components according to prior art.

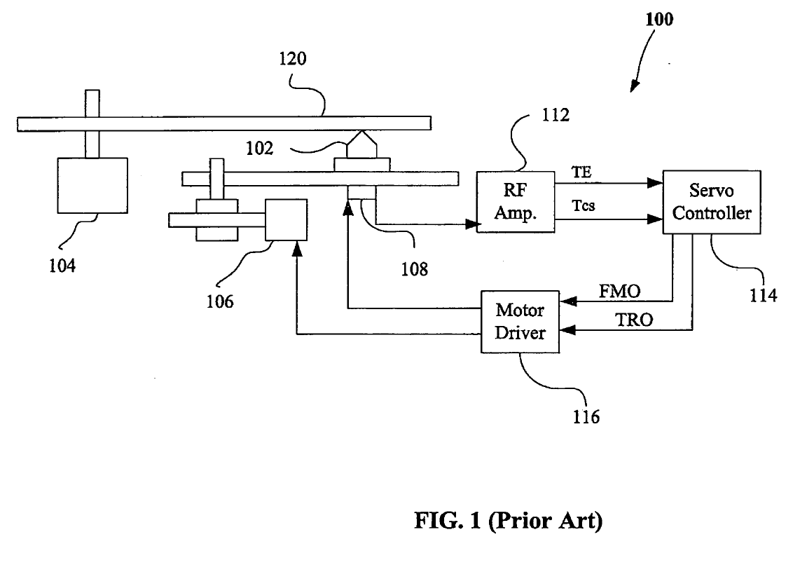

FIGS. 2A & 2B illustrate the Land/Groove orders the waveform of a TE signal, wherein FIG. 2A shows the waveform with no reverse occurring, and FIG. 2B shows the waveform with reverse occurring.

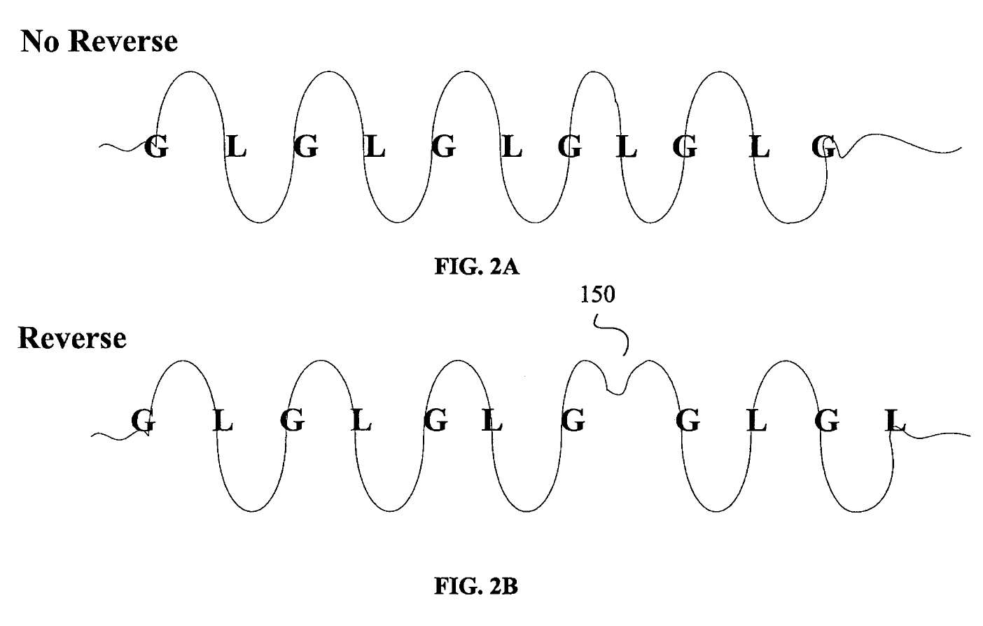

FIG. 3 is a functional block diagram illustrating a seeking control system of an optical disc drive according to the present invention.

FIG. 4 shows a flow chart of the seeking control method of the present invention.

### DETAILED DESCRIPTION OF THE PREFERRED EMBODIMENTS

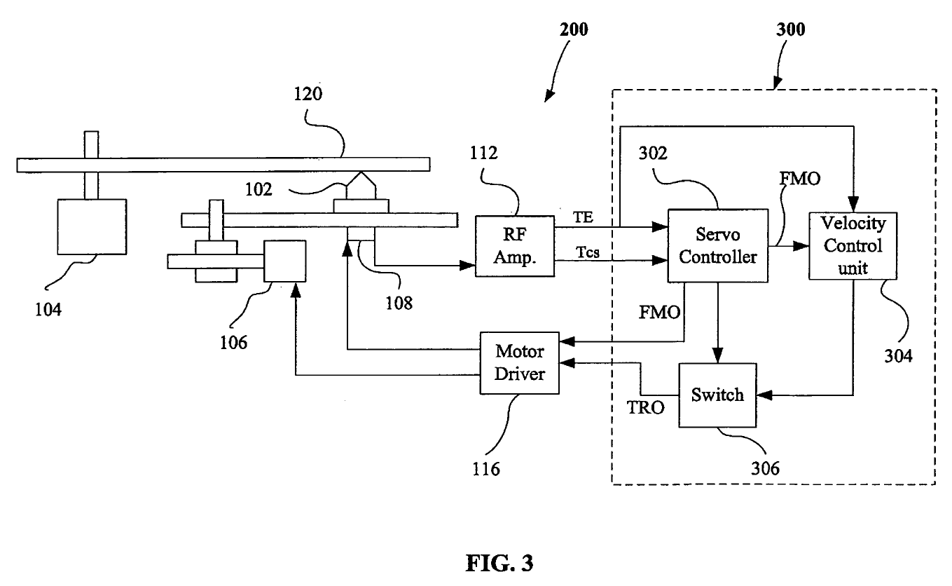

Please refer to FIG. 3, which is a functional block diagram illustrating a seeking control system 300 of an optical disc drive 200 according to the present invention. According to one embodiment of the present invention, the pickup head 102, the spindle motor 104, the sled motor 106, the tracking coil 108, the RF amplifier 112, and the motor driver 116 is operated the same as described in above. The seeking control system 300 according to this embodiment of the present invention comprises a servo controller 302, a velocity control unit 304 and a switch unit 306.

When the optical disc drive 200 performs a seeking operation, the servo controller 302 receives the TE signal and the Tcs signal from the RF Amp 112, and generates a FMO signal and a first tracking control signal accordingly. The first tracking control signal is generated by compensating the Tcs signal for controlling the tracking coil 108 in the middle of the sled motor 106. As description above, a FMO signal is used to control the sled motor 106 to move the PUH 102 to the target position. The FMO signal is generated by referring to a Flexible Macroblock Ordering profile, which provides the pulses arrangement for the sled motor 106. The FMO signal can be generated by the servo controller 302 or by the other servo element in the optical disc drive 200 which is not restricted according to the present invention.

The present invention also employs a velocity control unit 304 and a switch unit 306 in the seeking control system 300. The velocity control unit 304 receives the TE signal and determines a velocity of the PUH 102 accordingly. In one embodiment, the velocity of the PUH 102 could be the frequency of the TE signal. The velocity control unit 304 makes a velocity estimation to generate the second tracking control signal. The velocity estimation is to compare velocity of the PUH 102 with a predetermined velocity profile. The second tracking control signal is generated by compensating errors between the velocity of the PUH 102 and the predetermined velocity profile. The predetermined velocity profile could be a predetermined frequency, a frequency profile, or the FMO signal. In one embodiment, the predetermined frequency can be the runout frequency for the optical disc. Regarding the DVD-RAM disc, 20 k Hz is preferably used.

Both the servo controller 302 and the velocity control unit 304 are coupled to a switch unit 306. Once the frequency of the tracking error signal (TE) gets slower than the predetermined frequency, a predetermined number of the pulses of the FMO signal for a long seeking is going to reach, or the seeking operation gets in the last portion of the velocity profile of the FMO signal, the switch unit 306 switches connection from the servo controller 302 to the velocity control unit 304. That is, the TRO signal is switched from the first tracking control signal to the second tracking control signal to force the pickup head 102 into a stable velocity control mode. Thereafter, as the seeking operation is close to the end, the pickup head 102 moves stably without reverse. In one embodiment, the switch unit 306 could be a multiplexer.

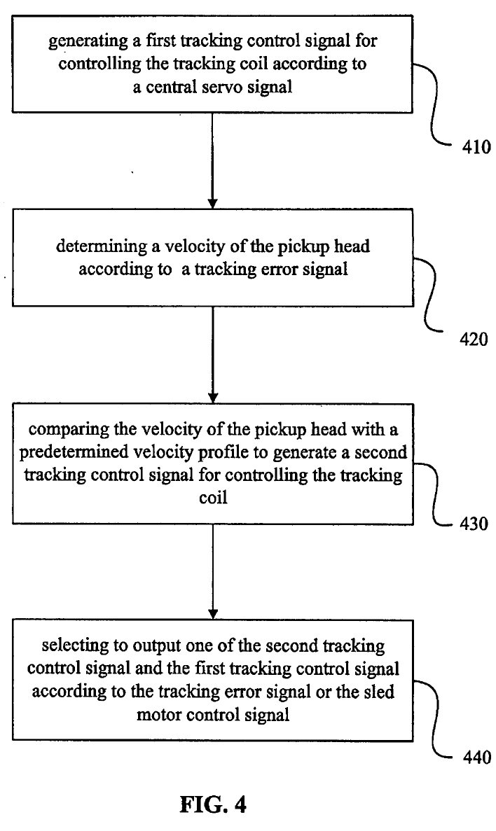

Please refer to FIG. 4, which shows a flow chart of the seeking control method of the present invention. For accomplishing the objective of the present invention to control a pickup head mounted on the tracking coil carried by a sled motor of an optical disc drive stably in a seeking operation, the seeking control method of the present method includes the following steps:

In step 410, generating a first tracking control signal for controlling the tracking coil according to a central servo signal;

In step 420, determining a velocity of the pickup head according to a tracking error signal;

In step 430, comparing the velocity of the pickup head with a predetermined velocity profile to generate a second tracking control signal for controlling the tracking coil; and

In step 440, selecting to output one of the second tracking control signal and the first tracking control signal according to the tracking error signal or the sled motor control signal.

In conclusion, the seeking control system and method of an optical disc drive according to the present invention prevent the PUH from happening of the “reverse” and then the optical disc drive becomes unstable, therefore, the present invention prevent can control a pickup head stably in a seeking operation. Therefore, failure of the servo control can be avoided.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A seeking control system for controlling a pickup head of an optical disc drive, the pickup head being mounted on a tracking coil carried by a sled motor, a sled motor control signal being used to control the sled motor during a seeking operation, the system comprising:
a servo controller for receiving a central servo signal from the pickup head to output a first tracking control signal for controlling the tracking coil;
a velocity control unit for receiving a tracking error signal to determine a velocity of the pickup head, and comparing the velocity of the pickup head with a predetermined velocity profile to generate a second tracking control signal for controlling the tracking coil; and
a switch unit, coupled to the servo controller and the velocity control unit, selecting to output one of the first tracking control signal and the second tracking control signal according to the tracking error signal or the sled motor control signal.

2. The seeking control system of claim 1, wherein the predetermined velocity profile is a predetermined frequency, and the velocity of the pickup head is a frequency of the tracking error signal.

3. The seeking control system of claim 2, wherein the switch unit selects to output one of the first tracking control signal and the second tracking control signal by comparing the predetermined frequency with the frequency of the tracking error signal.

4. The seeking control system of claim 2, wherein the switch unit outputs the second tracking control signal when the frequency of the tracking error signal is lower than the predetermined frequency.

5. The seeking control system of claim 2, wherein the predetermined frequency is an over runout frequency for a disc.

6. The seeking control system of claim 1, wherein the second tracking control signal is generated by compensating the difference between the tracking error signal and the predetermined velocity profile to control the pickup head on the tracking coil stably moving in the optical disc drive.

7. The seeking control system of claim 1, wherein the predetermined velocity profile is the sled motor control signal, and the velocity of the pickup head is the frequency of the tracking error signal.

8. The seeking control system of claim 1, wherein the switch unit selects to output the second tracking control signal if a number of the pulses of the sled motor control signal reaches a predetermined number.

9. The seeking control system of claim 1, wherein the switch unit selects to output the second tracking control signal if the seeking operation is in the last portion of the sled motor control signal.

10. The seeking control system of claim 1, wherein the predetermined velocity profile is a varied frequency of the tracking error signal, and the velocity of the pickup head is the frequency of the tracking error signal.

11. A seeking control method for controlling a pickup head mounted on the tracking coil carried by a sled motor of an optical disc drive, the sled motor being controlled by a sled motor control signal during a seeking operation, the method comprising the steps of:
generating a first tracking control signal for controlling the tracking coil according to a central servo signal;
determining a velocity of the pickup head according to a tracking error signal;
comparing the velocity of the pickup head with a predetermined velocity profile to generate a second tracking control signal for controlling the tracking coil; and
selecting to output one of the second tracking control signal and the first tracking control signal according to the tracking error signal or the sled motor control signal.

12. The seeking control method of claim 11, wherein the predetermined velocity profile is a predetermined frequency, and the velocity of the pickup head is a frequency of the tracking error signal.

13. The seeking control method of claim 12, wherein selecting step is performed by comparing the predetermined frequency with the frequency of the tracking error signal.

14. The seeking control method of claim 12, wherein the second tracking control signal is selected to output when the frequency of the tracking error signal is lower than the predetermined frequency.

15. The seeking control method of claim 12, wherein the predetermined frequency is an over runout frequency for a disc.

16. The seeking control method of claim 11, wherein the second tracking control signal is generated by compensating the difference between the tracking error signal and the predetermined velocity profile to control the pickup head on the tracking coil stably moving in the optical disc drive.

17. The seeking control method of claim 11, wherein the predetermined velocity profile is the sled motor control signal, and the velocity of the pickup head is the frequency of the tracking error signal.

18. The seeking control method of claim 11, wherein the second tracking control signal is selected to output if a number of the pulses of the sled motor control signal reaches a predetermined number.

19. The seeking control method of claim 11, wherein the second tracking control signal is selected to output if the seeking operation is in the last portion of the sled motor control signal.

20. The seeking control method of claim 11, wherein the predetermined velocity profile is a varied frequency of the tracking error signal, and the velocity of the pickup head is the frequency of the tracking error signal.
